(19) United States
(12) Patent Application Publication
(10) Pub. No.: US 2025/0154722 A1
(43) Pub. Date: May 15, 2025

(54) ANISOTROPIC AND ELECTRONICALLY CONDUCTING HYDROGEL

(71) Applicants: Mahiar Max HAMEDI, Täby (SE); Tobias BENSELFELT, Sundbyberg (SE)

(72) Inventors: Mahiar Max HAMEDI, Täby (SE); Tobias BENSELFELT, Sundbyberg (SE)

(21) Appl. No.: 18/839,361

(22) PCT Filed: Dec. 30, 2022
(86) PCT No.: PCT/SE2022/051254

§ 371 Date: Aug. 16, 2024

(30) Foreign Application Priority Data
Feb. 25, 2022 (SE) 2250258-7

(51) Int. Cl. D21H 11/18; B82Y 15/00; B82Y 30/00; D21H 17/67; D21H 19/12; D21H 21/14; D21H 21/52

(52) U.S. Cl. CPC D21H 11/18; D21H 17/67; D21H 19/12; D21H 21/14; D21H 21/52; B82Y 15/00; B82Y 30/00

(57) ABSTRACT

An anisotropic and electronically conducting hydrogel and an actuator or an adjustable membrane including such a hydrogel. The hydrogel is a layered structure including a hydrophilic nanofibril material and electronically conductive elongated nanoparticles, both extending primarily in an x-y plane of the hydrogel. The density of the hydrogel varies in a substantially periodic way along the z-axis providing alternating loose layers and dense layers.

### FIELD OF INVENTION

The present invention relates to an anisotropic and electronically conducting hydrogel comprising a nanofibril material and electronically conductive nanoparticles. In particular, the present invention relates to an anisotropic and electronically conducting hydrogel that may function as an actuator or an adjustable membrane.

### BACKGROUND

Natural organisms use predominantly soft materials to integrate sensing (e.g., vision and touch), actuation (molecular machines, e.g., muscles), and communication/computation (neurons). This multifunctional integration allows organisms to regulate advanced internal functions, and intelligently interact with objects in their surroundings. Organisms have long been an inspiration for human-made machines. Modern machines are, however, primarily fabricated using rigid parts designed to perform a single function and are therefore still inferior to organisms. New multifunctional materials inspired by nature have the potential to enable future machines with capabilities beyond current technologies. Ideally, these materials should be soft, like biological materials, but electronically embed multiple functions throughout their bulk structure, rather than biochemically, to seamlessly integrate with modern batteries and computers.

To achieve these properties, soft electroactive materials are needed, preferably with direct electronic control of the bulk of the material so that no additional equipment; such as external electrodes, pumps, light sources, or heating elements, are required. In this pursuit, four principal mechanisms for direct electronic control have been proposed: i) electrostatic actuators relying on Maxwell stress, ii) ionic gels relying on the migration of ions in external electric fields, iii) conducting polymer actuators relying on the doping/de-doping of ions, and iv) actuators relying on the insertion of ions into the double layers of carbon nanomaterials. However, few of these technologies are as soft and adaptable as biological systems and none easily integrate sensing, actuation, and computation within the same material platform.

M. M. Hamedi et al. ‘Highly conducting, strong nanocomposites based on nanocellulose-assisted aqueous dispersions of single-wall carbon nanotubes’ ACS Nano 2014, vol 8, no 3, pp 2467-2476, discloses conductive nanofibrillated cellulose (NFC) composites comprising single-wall nanotubes. T. Benselfelt and L. Wigberg ‘Unidirectional swelling of dynamic cellulose nanofibril networks: A platform for tunable hydrogels and aerogels with 3D shapeability’, Biomacromolecules 2019, issue 20, pp 2406-2412, discloses unidirectional swelling of cellulose nanofibrils and alginate networks.

CN110183688A discloses a method for preparing a sensor based on a nanocellulose-carbon nanotube conductive hydrogel.

CN 112409627A discloses a method for forming a membrane comprising cellulose nanofibers and graphene.

In the prior art there is a need for an improved soft electroactive material suitable for use as an actuator and/or adjustable membrane.

### SUMMARY

The object of the present invention is to overcome the drawbacks associated with prior art electroactive materials and device based on prior art electroactive materials. This is achieved by the anisotropic and electronically conducting hydrogel, the production method, the actuator and the tunable membrane as defined in the claims.

According to one aspect of the invention an anisotropic and electronically conducting hydrogel is provided. The anisotropic and electronically conducting hydrogel comprises a layered structure. The layers of the layered structure extend in the x-y plane of the hydrogel and are stacked along the z-axis of the hydrogel. The hydrogel comprises a hydrophilic nanofibril material comprising hydrophilic nanofibrils. A majority of the hydrophilic nanofibrils are extended primarily in the x-y directions of the hydrogel. The hydrogel also comprises electronically conductive elongated nanoparticles having an aspect ratio above 10. A majority of the electronically conductive elongated nanoparticles are extended primarily in the x-y directions of the hydrogel. The hydrogel further comprises 50-95 vol % aqueous electrolyte of the total volume of the hydrogel. According to the invention, the density of the hydrogel varies in periodically along the z-axis of the hydrogel, providing alternating loose layers and dense layers.

According to one embodiment of the invention, the layered structure has an average pore size of above 20 nm when in the dry state, i.e., excluding the aqueous electrolyte.

According to one embodiment of the invention, the hydrophilic nanofibril material comprises cellulose nanofibrils.

According to one particular embodiment of the invention, 90% of the cellulose nanofibrils have a width of 1.5-3.5 nm, and a length of 0.5-1.5 μm.

According to one embodiment of the invention, the nanofibril material have an average aspect ratio of or above 100, preferably of or above 400.

According to one embodiment of the invention, the hydrophilic nanofibril material is anionically or cationically charged.

According to one embodiment of the invention, the electronically conductive elongated nanoparticles are selected from the group consisting of carbon nanotubes (CNTs), graphene, and MXene or any mixture of those.

According to one embodiment of the invention, the electronically conductive elongated nanoparticles is carbon nanotubes and the amount of electronically conductive elongated nanoparticles in the hydrogel is 30-60 wt % of the total weight of the layers, preferably 30-45 wt % of the total weight of the layers, more preferably around 45 wt % of the total weight of the layers.

According to one embodiment of the invention 90% of the carbon nanotubes has a width of 4-10 nm, and a length of 1.2-2 μm. Preferably, 90% of the carbon nanotubes has a width 4-7 nm, more preferably 4-6 nm.

According to one embodiment of the invention, a majority of the carbon nanotubes are single walled carbon nanotubes.

According to one embodiment of the invention, the majority of the electronically conductive elongated nanoparticles are not in direct contact with any other electronically conductive elongated nanoparticles.

According to one aspect of the invention an actuator is provided comprising the anisotropic and electronically conducting hydrogel described above.

According to one aspect of the invention a tunable membrane is provided comprising the anisotropic and electronically conducting hydrogel described above.

According to one aspect of the invention a method of forming a hydrogel is provided. The method comprises the steps of:
dispersion of hydrophilic nanofibrils, preferably cellulose nanofibrils, and electronically conductive elongated nanoparticles with an aspect ratio of 10 or higher in water to form a dispersion;
filtration of the dispersion to form an anisotropic wet sheet;
drying the wet sheet for a pre-determined time period to form a dried layered structure; and
immersing the dried layered structure in an aqueous electrolyte.

Thanks to the invention an anisotropic and electronically conducting hydrogel is provided with direct electric activation achieving unidirectional electroosmotic expansion of up to 300%. This hydrogel makes it possible to realize soft intelligent systems with monolithically integrated actuation, sensing, permeability control, and computation. Advantages of the inventive hydrogel material will be further discussed in the detailed description.

### DEFINITIONS AND ABBREVIATIONS

‘anisotropic’—an anisotropic material is a material that assumes different properties in different directions, it can be described as a difference when measured along different axes;
‘nanofibrils’—refers to a thread-like materials having a thickness in the nm range and a length in the μm range;
‘aqueous electrolyte’—refers to water with ions, such as an aqueous solution of sodium, potassium or magnesium salts or dissolved carbon dioxide;
‘vol %’—short for volume percent, ratio of the volume of one substance contained in another substance;
‘wt %’—short for weight percent, or mass fraction, the weight of one compound relative to the total weight of all compounds in a mixture;
‘CNF’—short for cellulose nanofibers;
‘CNT’—short for carbon nanotubes;
‘MXene’—refers to a-few-atoms-thick layers of transition metal carbides, nitrides, or carbonitrides, such as Ti₃C₂ MXenes;
‘PBS’—phosphate buffered saline;
‘TBA’—Tetrabutylammonium chloride;

### LIST OF FIGURES

FIG. 1 a), b), c) and d) are illustrations of embodiments of the invention;

FIG. 2 a) is a graph and an image showing the expansion of a hydrogel as a function of the time exposed to −1V for one embodiment of the invention, b) is a graph showing expansion as a function of the time exposed to −1V for one embodiment of the invention, and c) is a graph showing relative electric resistance [(R—R₀)R₀⁻¹)] as a function of swelling of the hydrogel [(%)] for one embodiment of the invention;

FIG. 3 is a schematic illustration of one embodiment of the invention;

FIG. 4 a) and b) are graphs showing expansion as a function of time at different potentials for one embodiment of the invention;

FIG. 5 is a schematic illustration of one embodiment of the invention;

FIG. 6 is a graph of the expansion of a hydrogel in different electrolytes as a function of time;

FIG. 7 is a graph showing the expansion (as distance to the sensor) as a function of cycle number for a hydrogel under 1 kg load, the cycle settings were −2V for 5 min followed by +2V for 5 min; and

FIG. 8 illustrates the actuation performance of a hydrogel comprising 60% MXene sheets (thickness 2 nm and lateral size of up to 5 μm) and 40% CNFs (thickness 2-3 nm and length of 1-3 um.) The hydrogel was cycled by applying −1 V (expansion) for 20 s, 1 min, or 2 min, followed by +1 V (contraction) for the same duration, completing a cycle.

### DETAILED DESCRIPTION

This invention relates to electronically conductive, anisotropic, nanowire or nanosheet hydrogels. The hydrogels are formed by vacuum filtration of aqueous dispersions, drying, and swelling in an electrolyte. Direct electric activation results in uniaxial electroosmotic expansion of the hydrogel.

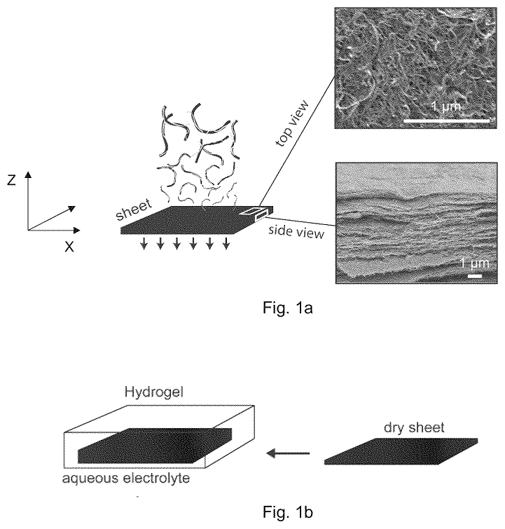

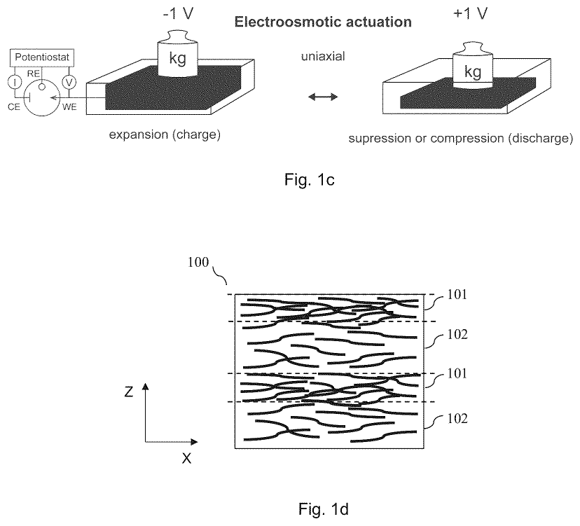

In a first aspect of the invention, there is an anisotropic and electronically conducting hydrogel 100 comprising a layered structure, see FIG. 1d. The layers 101, 102 of the layered structure extend in the x-y plane of the hydrogel 100 and are stacked along the z-axis of the hydrogel 100. The hydrogel 100 comprises a hydrophilic nanofibril material comprising hydrophilic nanofibrils. A majority of the hydrophilic nanofibrils are extended primarily in the x-y directions of the hydrogel 100. The hydrogel 100 also comprises electronically conductive elongated nanoparticles having an aspect ratio above 10. A majority of the electronically conductive elongated nanoparticles are extended primarily in the x-y directions of the hydrogel 100. The hydrogel 100 further comprises 50-95 vol % aqueous electrolyte of the total volume of the hydrogel 100, preferably 70-90 vol % aqueous electrolyte.

The density of the hydrogel 100 varies in a substantially periodic way, i.e., periodically, along the z-axis of the hydrogel 100, providing alternating loose layers 102 and dense layers 101.

As used herein the loose layers 102 have an average density that lower than an average density of the dense layers 101, i.e., the loose layers 102 are less dense than the dense layers 101.

The average density of each loose layer 102 of the hydrogel 100 is preferably substantially the same as the average density of other loose layers 102 of the hydrogel 100. The embodiments are, however, not limited thereto. Hence, different loose layers 102 of the hydrogel 100 could have different average densities as long as these different average densities of the loose layers 102 are lower than the average density or densities of the dense layers 101.

Correspondingly, the average density of each dense layer 101 of the hydrogel 100 is preferably substantially the same as the average density of other dense layers 101 of the hydrogel 100. The embodiments are, however, not limited thereto. Hence, different dense layers 101 of the hydrogel 100 could have different average densities as long as these different average densities of the dense layers 101 are higher than the average density or densities of the loose layers 102.

As is indicated in FIG. 1d, the layered structure of the hydrogel 100 comprises multiple, i.e., at least two, layers 101, 102 of alternating density. In such a case, the layers 101, 102 could, when traveling through the thickness of the hydrogel 100, i.e., along the Z-axis, be arranged as follows i) loose layer 102, dense layer 101, . . . , loose layer 102, ii) loose layer 102, dense layer 101, . . . , dense layer 101, iii) dense layer 101, loose layer 102, . . . , dense layer 101, or iv) dense layer 101, loose layer 102, . . . , loose layer 102. Thus, in various embodiments, the hydrogel 100 comprises N dense layers 101 and N loose layers 102, N dense layers 101 and N-1 loose layers 102 or N-1 dense layers 101 and N loose layers 102, wherein N is an integer number equal to or larger than two. The value of N depends on the thickness of the hydrogel 100. As an illustrative example, assuming that each dense layer 101 and each loose layer 102 has an average thickness of about 300 nm and the hydrogel 100 has a total thickness of 50 μm, then the hydrogel 100 comprises about 167 layers in total so that N could be about 83.

As the skilled person understands, the layers 101, 102 can also be described as regions in the hydrogel 100 with a gradual change in density in-between. Hence, the density of a hydrogel 100 according to the invention varies along the z-axis but does not have a sharp boundary in any given plane along the x- and y-axes. FIG. 1a shows an example of an electronically conductive, anisotropic layered structure in top and side view. The layers extend in the x-y plane and are stacked on top of each other along the z-axis. The SEM image in FIG. 1a is an image of a dry structure, i.e., in a dry state. To form a hydrogel, the dried layered structure is immersed in an aqueous electrolyte, preferably 10 mM. This is illustrated in FIG. 1b. Subsequently, the hydrogel can be activated electronically to further swell via electroosmosis. This is illustrated in FIG. 1c. Hence, FIG. 1b shows a schematic illustration of how the dry structure (dry sheet) swells anisotropically once it is placed in an aqueous electrolyte, forming a hydrogel, and FIG. 1c illustrates that the hydrogel may swell further by electroosmosis when the hydrogel is connected to an electronic circuit and a voltage is applied the hydrogel. Depending on the voltage, the electroosmosis can be used to expand or suppress/contract the hydrogel.

As mentioned in the foregoing, the hydrogel 100 comprises 50-95 vol % aqueous electrolyte (water with ions), preferably 70-90 vol %. The density of the hydrogel 100 varies in a substantially periodic way, i.e., periodically, along the z-axis, while it does not vary in any substantive way along the x- and y-axis. This means that the hydrogel 100 can be described as a stack of layers 101, 102, wherein the density of the layers 101, 102 varies. The stack structure is visible in the SEM image in FIG. 1a and the schematic illustration in FIG. 1d. Alternatively, the hydrogel 100 can be described as comprising alternating dense layers 101 and loose layers 102 with a gradual change in between. As an illustrative example, the thickness of each layer 101, 102 in the hydrogel 100 is approximately 200-500 nm, preferably 300-400 nm.

Alternatively, the hydrogel 100 can be described as comprising sheets or stacks or layers 101, 102 that are held together in the z-direction by different forces. Without being bound by any theory, the different forces may be Van der Waals forces, ionic interaction, and/or entanglement of the nanofibril material between the different layers/stacks/sheets 101, 102, it can also be a mixture of different forces or interactions.

Alternatively, the hydrogel 100 can be described as it comprises different alternating regions 101, 102 in the z-direction, where some regions can swell/expand more than others.

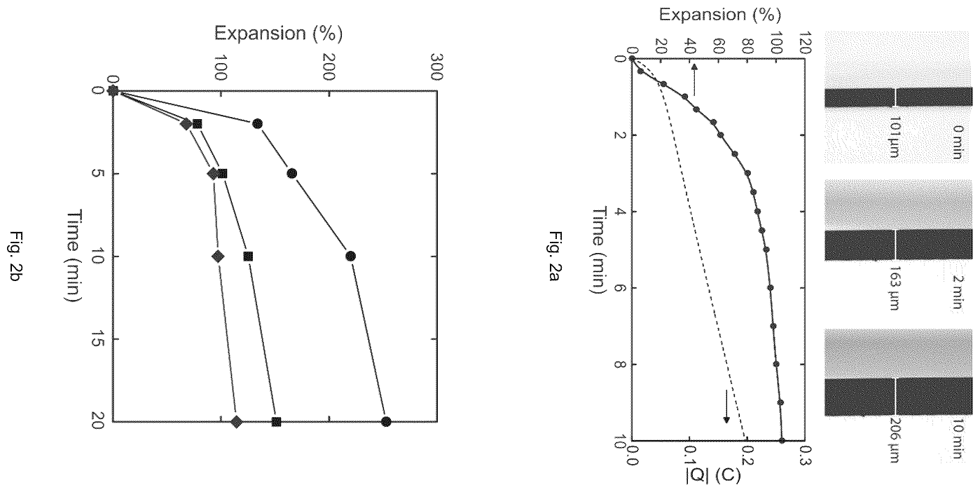

A hydrogel according to the invention is electronically conducting with a sheet resistance in the order of a few Ω/□ (Ohm per square) in the dry state. This sheet resistance of the hydrogel decreases with increasing CNT content (increasing content of electronically conductive elongated nanoparticles). The resistance increase is directly proportional to the swelling (gauge factor 1.4), this can be seen in FIG. 2c. This FIG. 2c shows the relative resistance of the hydrogel 100 ((R—R₀)R₀⁻¹) as a function of swelling in deionized water for a hydrogel 100 comprising 45 wt % CNT with the gauge factor calculated from the slope. The gauge factor is surprisingly low. As can be seen in the figure, the electronical conductivity is maintained in the hydrogel even after significant swelling of above 100%. This is in contrast to membranes of the prior art that generally are electronically conducting in their dry state and not in the swollen state. Without being bound by any theory, this may be due to the composition and layered structure of a hydrogel 100 according to the invention with the denser layers 101 preserving the electronic conductivity while the loose layers 102 allow high swelling. The electronical conductivity of a hydrogel 100 according to the invention in its swollen state enables the use of such a hydrogel 100 as an actuator with electronical control in the swollen state.

The hydrogel 100 comprises a hydrophilic nanofibril material and electronically conductive elongated nanoparticles arranged in the layers 101, 102. Electronically conductive elongated nanoparticles may refer to a nanowire or nanosheet material, having an aspect ratio of 10 or above. Aspect ratio as referred to herein represent the ratio between the longest dimension and the shortest dimension of the electronically conductive elongated nanoparticles. For instance, an electronically conductive nanofiber typically has length and diameter, or width parameters and the aspect ratio is then the ratio between the length and the diameter or width. Correspondingly, an electronically conductive nanosheet material generally has larger length and width or diameter as compared to the thickness and the aspect ratio is then defined as the ratio between the length, width or diameter and the thickness. Electronically conductive elongated nanoparticles having an aspect ratio of 10 or above includes, for example, carbon nanotubes, MXene, and graphene.

Hydrophilic nanofibril materials refer to hydrophilic rod-shaped materials having a thickness in the nm range and a length in the μm range. Examples of such materials include nanocellulose nanofibrils, protein nanofibrils, and chitin nanofibrils.

The hydrogel 100 further comprises 50-95 vol % aqueous electrolyte of the total volume of the hydrogel 100, preferably 70-90 vol % aqueous electrolyte. An ion concentration of the aqueous electrolyte about 10 mM is suitable. In one embodiment the electrolyte is selected from the group consisting of PBS, LiCl, NaCl, and sea water or mixtures of those.

Electronically conducting elongated nanoparticles of the hydrogel 100 having a high aspect ratio, such as 10 or above, preferably 100 or above, more preferably 400 or above, such as 1000 or above, may be beneficial for the formation of the layered structure and/or a hydrogel 100 according to the invention. The electronically conductive elongated nanoparticles form a semi-ordered structure by being arranged in the x-y plane in the layers 101, 102, i.e., the electronically conducting elongated nanoparticles extend primarily in the x-y plane of the hydrogel 100.

FIG. 2a shows real-time micrographs (upper part) together with data of the electroosmotic swelling (lower part) of a hydrogel 100 with 45 wt % CNT content in a 10 mM NaCl solution. As can be seen in the graph, the initial expansion rate was 46% min-, and the hydrogel 100 expanded from its initial equilibrium state to 60% after 2 min, and 100% after 10 min. FIG. 2b shows expansion as a function of time for different CNT contents: ● 30 wt % CNT, ▪ 45 wt % CNT, and ♦ 60 wt % CNT. As can be seen, a higher CNT content results in a lower swelling, possibly due to a higher cohesion in the network forming the hydrogel 100. FIG. 2c shows the relative resistance of the hydrogel 100 ((R—R₀)R₀⁻¹) as a function of swelling in deionized water for a hydrogel 100 comprising 45 wt % CNT. As can be seen, the relative resistance is directly proportional to the swelling, which can be used for self-sensing the expanded state.

Without being bound by any theory, it is possible that the denser layers 101 allow high electric conductivity, while the less dense layers 102 in-between allow for fast transport of ions and water. It is further possible that the denser layers 101 are more ordered than the less-dense layers 102, which could be more random.

A hydrogel 100 according to the invention can be described as a porous network. In the dry layered structure, exemplified in FIG. 1a, the layers 101, 102 comprise pores with an average size in the order of 20 nm in diameter. The dry state of the hydrogel is the state prior to immersing the dry layered structure in the aqueous electrolyte. In the expanded hydrogel state, the pores are typically expanded to be larger than 20 nm. The degree of expansion controls the average pore size.

CNFs are high aspect ratio nanoparticles of crystalline cellulose, the structural building block of trees and plants. They are extracted by chemical modification and mechanical disintegration of wood pulp and constitute an abundantly available renewable nanomaterial used to fabricate nanostructured materials.

In one embodiment of the invention, the hydrogel network has an average pore size of above 20 nm when in the dry state.

In one embodiment of the invention, the hydrophilic nanofibril material comprises cellulose nanofibrils.

In one embodiment of the invention, the nanofibril material have an average aspect ratio of or above 100, or of or above 400.

In one embodiment of the invention, the hydrophilic nanofibril material is anionically or cationically charged. The sign of the charge of the nanofibrils, i.e., positively charged or negatively charge, determine at what sign (positive or negative) of the applied potential the material expands: for anionic nanofibrils negative potential and for cationic nanofibrils positive potential.

It is an advantage that CNF nanocomposites can also be shaped into advanced 3D objects, such as extruded threads or 3D-printed patterns.

In one embodiment of the invention, the electronically conductive elongated nanoparticles are selected from the group consisting of carbon nanotubes (CNTs), graphene, and MXene or any mixture of those.

In one embodiment of the invention, the electrically conductive elongated nanoparticles are carbon nanotubes. Preferably, 90% of the carbon nanotubes has a width 4-10 nm, preferably 4-7 nm, and more preferably 4-6 nm. In one embodiment, a majority of the carbon nanotubes are single walled carbon nanotubes. A too large width of the carbon nanotubes may result in a hydrogel 100 with poorer percolation, cohesion in the sheet and lower conductivity.

An advantage of a hydrogel 100 comprising CNFs (including CNTs) is that it forms an open yet strong fibrillar network (G′˜1 kPa at 99 vol % water content). These combined properties are desirable for soft electroactive materials in systems where high conductivity and mesoporosity are necessary.

It is an advantage that CNFs and CNTs are both abundant materials. A hydrogel 100 comprising those components can, thus, be produced at a low cost and large scale.

A hydrogel 100 according to the invention may be produced with a suitable thickness that depends on the application, such as artificial muscle, drug delivery device, or fractionation device. The skilled person will be able to determine a suitable thickness and fabricate the hydrogel 100 in that thickness using the method described further down. In one embodiment of the invention the thickness of the hydrogel is 10-100 μm, preferably 30-40 μm.

The amount of electronically conductive elongated nanoparticles in a hydrogel 100 may vary depending on, for example, the type of nanoparticles and the desired expansion of the hydrogel 100. In one embodiment of the invention, the electronically conductive elongated nanoparticles are carbon nanotubes and the amount of carbon nanotubes in the hydrogel 100 is 30-60 wt % of the total weight of the layers 101, 102, i.e., the dry structure before the addition of water. In other embodiments, the amount of carbon nanotubes is 30-45 wt % of the total weight of the layers 101, 102, preferably around 45 wt % of the total weight of the layers 101, 102. The total weight of the layers 101, 102 refers to the weight when water (aqueous electrolyte) is not included, i.e., only the weight of the solid (dry) components before adding the aqueous electrolyte (water).

As mentioned above, the aspect ratio of the electronically conductive elongated nanoparticles is 10 or above. In an embodiment, the aspect ratio of the hydrophilic nanofibril material is 10 or above. In one embodiment of the invention, the aspect ratio of the electronically conductive elongated nanoparticles and possibly the hydrophilic nanofibril material is 100 or above, 400 or above, or 1000 or above. The aspect ratio depends on the width and length of the hydrophilic nanofibril respectively of the electronically conductive elongated nanoparticles. In one embodiment of the invention, the electronically conductive material is carbon nanotubes wherein at least 90%, preferably at least 95%, of the carbon nanotubes have a width of 4-10 nm and a length of 1.2-2 μm. The length and width refer to the typical size or an interval of sizes as determined using atomic force microscopy (AFM). In one embodiment of the invention, the hydrogel 100 comprises CNF wherein at least 90%, preferably at least 95%, of the CNF have a width of 1.5-3.5 nm and a length of 0.5-1.5 μm.

In one embodiment of the invention, the electronically conducting material is MXene nanosheets, wherein at least 90% of the MXene nanosheets, preferably at least 95%, have a thickness of 2-11 nm and a length of around 5 μm. In a particular embodiment, the MXene nanosheets are Ti₃C₂ MXene nanosheets.

The hydrogel 100 can function as an actuator by applying a low voltage and the resulting capacitive double layer charging leads to electroosmotic swelling as illustrated in FIG. 1c. The swelling can be reversible, i.e., in form of an actuator. Switching between −1 V (positive swelling pressure) and +1 V (negative swelling pressure) allows for reversible actuation under load or without load depending on the composition of the hydrogel 100. As discussed above this is due to the electronical conductivity of the hydrogel 100.

As an example, FIG. 2a shows micrographs and data of the electroosmotic swelling of a hydrogel 100 with 45% CNT content in a 10 mM NaCl solution in the upper part of the figure. In the lower part of FIG. 2a, it is shown that the initial expansion rate was 46% min⁻¹ and the hydrogel 100 expanded from its initial equilibrium state to 60% and 100% after 2 min and 10 min, respectively. FIG. 2b shows the buildup of capacitive charge, which is rapid during the first 30 seconds and then reaches a constant rate of 0.016 C min⁻¹. Although the capacitive charge increases, the swelling approaches equilibrium. A higher CNT content results in a lower electroosmotic swelling as can be seen in FIG. 2b. At low CNT content of 30 wt %, the electroosmotic expansion approaches 300% (FIG. 2b).

Without being bound by any theory, the expansion of a hydrogel 100 is believed to decrease the percolation of the conducting network and increase the in-plane electric resistance of the bulk hydrogel. FIG. 2c shows that the relative resistance of a hydrogel 100 (R—R₀)R₀⁻¹ is directly proportional to the swelling in deionized water.

In FIG. 2, FIG. 2a shows a snapshot from the recorded electroosmotic swelling of a hydrogel 100 with 45 wt % CNT in the upper part, including the resulting expansion and charge accumulation as a function of time in the lower part. FIG. 2b shows expansion as a function of time for different CNT contents. FIG. 2c shows the relative electric resistance of a hydrogel 100 as a function of swelling.

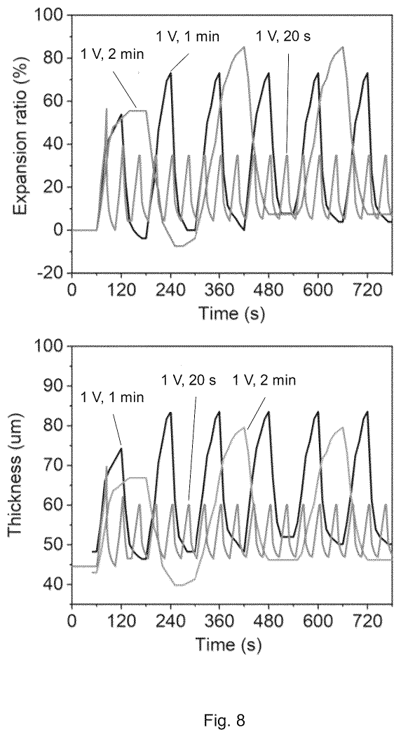

FIG. 8 illustrates the actuation performance of a hydrogel comprising 60% Ti₃C₂ MXene sheets (thickness 2 nm and lateral size of up to 5 μm) and 40% CNFs (thickness 2-3 nm and length of 1-3 um.) The hydrogel was cycled by applying −1 V (expansion) for 20 s, 1 min, or 2 min, followed by +1 V (contraction) for the same duration, completing a cycle.

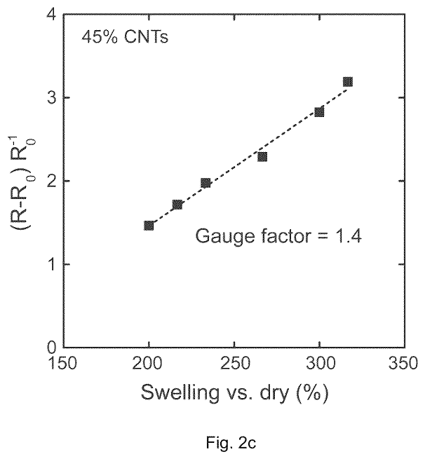

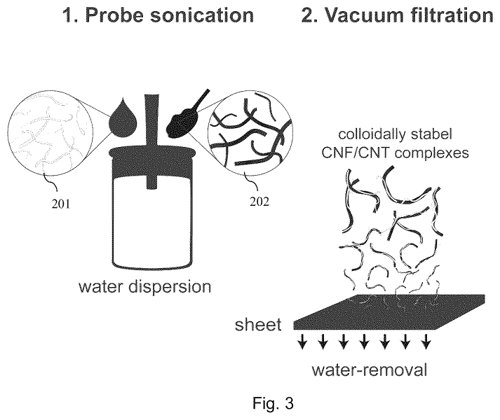

A second aspect of the invention relates to a method of manufacturing an anisotropic and electronically conducting hydrogel 100, see FIG. 3. The method comprises the steps of dispersion of hydrophilic nanofibrils 201, for example cellulose nanofibrils, and electronically conductive elongated nanoparticles 202 with an aspect ratio of 10 or higher in water to form a dispersion. The method also comprises filtration of the dispersion to form a layered structure and drying the layered structure for a pre-determined time period to form a dried layered structure. The method further comprises immersing the dried layered structure in an aqueous electrolyte, preferably an aqueous 10 mM electrolyte, for a pre-determined time period to form a hydrogel 100.

In one embodiment, a voltage is applied to the hydrogel 100, preferably a voltage around or less than ±1 Volt (V). When the voltage is applied, the hydrogel 100 can function as an actuator.

Without being bound by any theory, it may be important that the dispersion of the elongated electronically conductive nanoparticles are performed properly to obtain a homogenous mixture. A homogenous mixture may result in good percolation and a high conductivity in the swollen state. Such a homogenous mixture can be obtained by sonication. The time for sonication depends on the scale of the manufacturing and also other parameters in the method. This can be determined by the skilled person. For example, sonication for 10 min at 80% amplitude using a 1 cm in diameter probe results in a homogenous mixture, while a 5 min sonication using the same settings does not result in a homogenous mixture. In one embodiment, the majority of the elongated electronically conductive nanoparticles are not in direct contact with any other elongated electronically conductive nanoparticles. In particular, this may be the case during the formation of a percolating network. Poor dispersion of electronically conductive nanoparticles may lead to a lower percolation in the hydrogel 100.

One embodiment of the method is schematically illustrated in FIG. 3. In the filtration step, the water is removed. The filtration step is preferably performed using vacuum filtration. In the drying step, any remaining water from the filtration step is removed. The drying is preferably performed at elevated temperature such as 90-100° C. and under vacuum, such as a reduced pressure of 90-100 kPa. During the drying and filtration steps the dispersion self-assemble into layers 101, 102. After the drying step, the layered structure is immersed into an aqueous electrolyte where it is arranged to swell uniaxially forming a hydrogel 100.

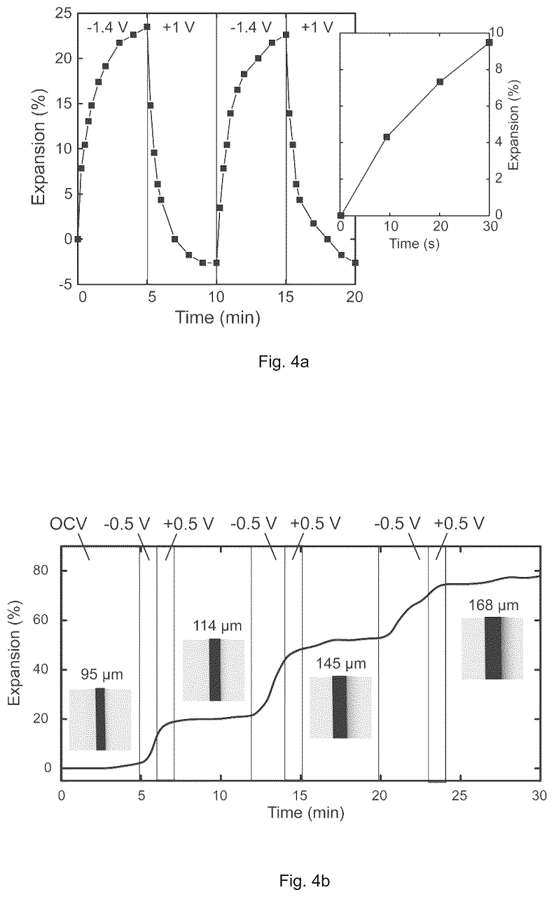

As described above, the hydrogel 100 is electronically activated by applying a low voltage, and the resulting capacitive double layer charging leads to electroosmotic swelling as illustrated in FIG. 1b and FIG. 2a. The swelling can be reversible, in form of an actuator. Switching between −1 V (positive swelling pressure) and +1 V (negative swelling pressure) allows for reversible actuation, for some compositions of the hydrogel 100 the swelling is reversible under load, shown in FIG. 4a.

It is an advantage that the surface charge of the CNFs can be anionic or cationic. When the hydrogel 100 comprises anionic CNFs, the hydrogel 100 expands at negative potentials and contracts or is suppressed at positive potential. When the hydrogel 100 comprises cationic CNFs, the hydrogel 100 expands at positive potentials and contracts or is suppressed at negative potential.

According to one aspect of the invention, there is an actuator comprising a porous, anisotropic, and electronically conducting hydrogel 100 according to the invention.

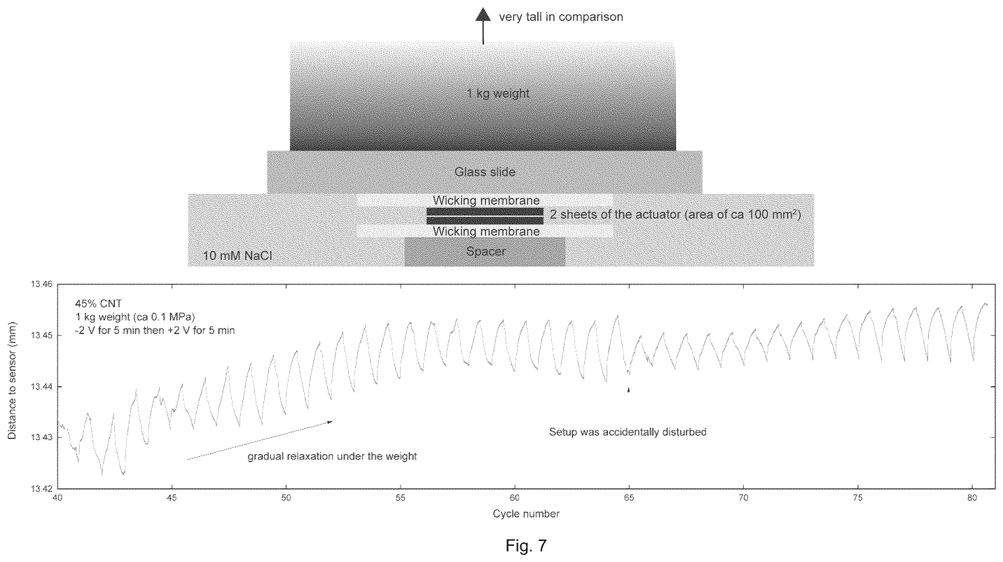

During use as an actuator, the working range should preferably be kept within a low voltage boundary (˜±1 V) to avoid unwanted electrochemical reactions with the aqueous electrolyte. Even in this range, the hydrogel 100 can expand up to 300%. It is an advantage with the invention that during use as an actuator the hydrogel 100 is stable. The cycling can be repeated under weight without any loss of function. This can for example be seen in FIG. 7 wherein an actuator has been cycled for 80 times under a 1 kg weight without any loss of function. The actuator may be described as relying on electroosmotic actuation. Capacitive charging or discharging results in an increased or decreased ion concentration inside the hydrogel 100, which generates a change in the osmotic pressure to balance the charges and in turn swelling or deswelling.

It is an advantage with the invention that the relationship between swelling and pore size of the hydrogel network allows precise control of the pore size and enables yet another feature: electronically tunable membranes. The expansion may increase the porosity and pore size of the hydrogel network, which determines its permeability and, thus, may provide a way to design electronically tunable membranes with a high level of control. It is an advantage that the components of hydrogels 100 according to the invention do not build an elastic pressure as they expand. Instead, they deform plastically (stick-slip-stick behavior), possibly due to inter-particle bond disruption during swelling. This means that the expansion can be controlled in steps to tune the porosity. FIG. 4b shows a stepwise controlled expansion of a hydrogel 100 as a function of time and applied voltage.

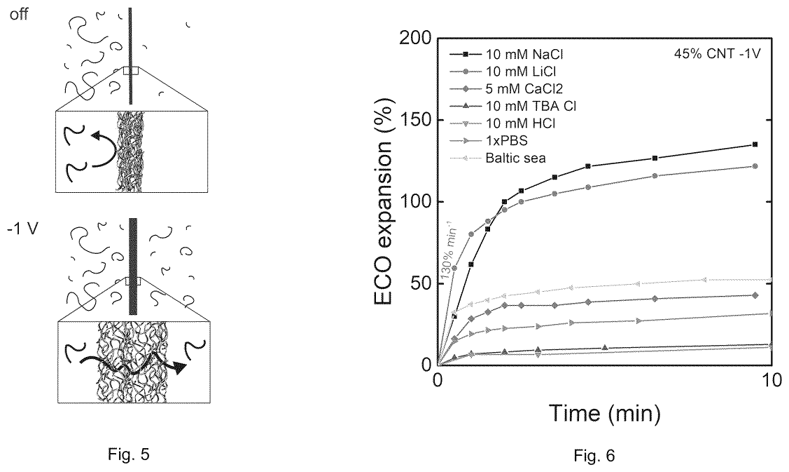

In one aspect of the invention, there is a tunable membrane comprising an anisotropic and electronically conducting hydrogel 100 according to the invention. Such a membrane is schematically illustrated in FIG. 5. The electroosmotic swelling opens up the hydrogel network, which results in an increased pore size distribution. The level of expansion, therefore, decides the size of molecules that can diffuse or be pushed through the membrane. The plastic deformation of the network also allows stepwise control as shown in FIG. 4b, which enables precise electronic tunability of the membrane permeability. This can be used for applications, such as electronically controlled drug delivery devices, separation membranes, or fractionation devices.

All aspects and embodiments may be combined unless specifically stated otherwise.

### EXPERIMENTS

### Materials

The cellulose source for TEMPO-oxidized CNFs (TO-CNFs) and cationic CNFs was a sulfite pulp from Nordic Paper AB, Sweden. Multi-wall CNT (art.no. 724769), sodium hypochlorite, TEMPO (2,2,6,6-tetramethylpiperidine-1-oxyl radical), and Fluorescein sodium salt were purchased from Sigma Aldrich. NaOH, NaCl and was purchased from VWR Sweden. Durapore PVDF (polyvinylidene difluoride) membrane filters (0.65 μm pore size, 90 mm in diameter) were purchased from Merck Millipore, Sweden, and were used as received. Carboxymethylated CNFs (CM-CNFs), as a 2 wt % gel, were purchased from RISE bioeconomy AB, Sweden. The Devanathan-Stachurski Cell (H cell) used for permeability measurements was purchased from Landt Instruments, US. Black Nunc MicroWell 96-well plates were purchased from Fisher Scientific.

### CNF Dispersions

High charge anionic TO-CNFs, and medium charge anionic carboxymethylated CNFs (CM-CNFs), or medium charge cationic CNFs were used. The TEMPO-mediated oxidation was conducted following the procedure developed by Saito et al. (Saito, T. et al Cellulose Nanofibers Prepared by TEMPO-Mediated Oxidation of Native Cellulose. Biomacromolecules 8, 2485-2491, (2007)) using 7.5 mmol sodium hypochlorite per gram of cellulose. The fibers were disintegrated by a microfluidizer (M-110EH, Microfluidics Corp.) via one pass through the big chambers (400 μm; 200 μm) and one pass through the small chambers (200 μm; 100 μm). The resulting 1 wt % gel was further diluted to 0.2 wt % by Ultra-Turrax at 13000 rpm for 20 min and centrifugation at 4100 g for 1 h to remove larger aggregates. CM-CNFs were homogenized by 3 extra passes through the small chamber in the microfluidizer and diluted as stated above. Cationic CNFs were prepared by quaternization according to Pei et al. (Pei et al. Surface quaternized cellulose nanofibrils with high water absorbency and adsorption capacity for anionic dyes. Soft Matter 9, 2047-2055, (2013)). The fibers were disintegrated by one pass through the small chambers of the microfluidizer and diluted as stated above. Polyelectrolyte titration was performed using a Stabino unit (Particle Metrix GmbH, Germany) where polydiallyldimethylammonium chloride was used to determine the charge density of the CNFs to 1.3 mmol g⁻¹, 0.5 mmol g⁻¹, and 0.6 mmol g⁻¹ for TO-CNFs, CM-CNFs, and cationic CNFs, respectively.

### CNF/CNT Dispersions

The 0.2 wt % CNF suspension was mixed with the dry powder of multi-walled CNTs and water to a final concentration of 0.1 wt % in a volume of 200 mL. The particles were dispersed by probe sonication for 10 min, at 80% amplitude, using a 13 mm probe. The dispersions were centrifuged for 30 min at 4100 g to remove aggregates.

### CNF/MXene Dispersions

The MXene (Ti₃C₂) dispersion was prepared according to Mathis et al. (Mathis, Tyler S et al. “Modified MAX phase synthesis for environmentally stable and highly conductive Ti3C2 MXene.” ACS nano 15.4 (2021): 6420-6429). MXene/CNF hybrid dispersions were prepared by mixing different amounts of CNF water dispersion and MXene dispersion.

### Sheet Preparation

The CNF/CNT or CNF/MXene dispersions were vacuum-filtered into sheets using a microfiltration assembly with Durapore PVDF membranes with 0.65 μm pore size and dried using a Rapid Köthen sheet drier (Paper Testing Instruments, Austria) at 93° C. and a reduced pressure of 95 kPa. Dried sheets were cut into suitable sizes using a razor blade. Cross-sections and the top of the sheets were imaged in an FE-SEM Hitachi S-4800 microscope.

An SEM image of a formed sheet containing CNT can be seen in FIG. 1a.

### Swelling and Expansion Measurements

The applied potential was controlled by a VSP potentiostat from BioLogic science instruments purchased from Cromocol Scandinavia AB (Borås, Sweden) or an Autolab PGSTAT204N with MUX 16 module from Metrohm Autolab, Sweden. In the case of measurements to probe the property space, the thickness of dry and swollen samples was determined by a micrometer (Mitutoyo, Japan). For detailed real-time studies, a USB digital microscope from DINO-lite at a magnification of 225-240× was used.

### Rheometer for Actuator Characterization

A Discovery HR2 parallel plate rheometer from Texas instrument was used to control the expansion and measure the normal pressure exerted by the hydrogel. A piece of hydrogel was connected as a working electrode, swollen passively or by a continuously applied potential, and placed between the plates with a piece of a Durapore membrane between the top plate and the membrane to have more access to the electrolyte. The gap of the plates was reduced in steps and the normal force was recorded after equilibrium was reached. The electrolyte concentration was 10 mM, and the CNT content was 45%.

### Mean Flow Pore Size

The mean flow pore size of a 45% CNT sample was kindly determined by the company Porometer, Berlin, Germany, using a POROLIQ1000 and a water/isobutanol combination.

### Actuation in Different Electrolytes

FIG. 6 shows the actuation (expansion) of the hydrogel in different electrolytes. As can be seen in the figure the hydrogel expands in LiCl, PBS and Baltic Sea water when −1V is applied. The expansion was fastest in LiCl. Furthermore, it can be seen that HCl and TBA (tetrabutylammonium) does not work efficiently.

### Repeated Cycling

FIG. 7 shows that the swelling mechanism of the hydrogel can be repeated under a weight of 1 kg without any indication of loss of function.

The hydrogel used for the experiment in FIG. 7 comprises 45% CNT and was cycled with −2V for 5 min followed by +2V for 5 min, the cycle was repeated 80 times.

1: An anisotropic and electronically conducting hydrogel comprising a layered structure, wherein the layers extend in the x-y plane of the hydrogel and are stacked along the z-axis of the hydrogel, and wherein the hydrogel comprises:
a hydrophilic nanofibril material comprising hydrophilic nanofibrils, wherein a majority of the hydrophilic nanofibrils are extended primarily in the x-y directions of the hydrogel;
electronically conductive elongated nanoparticles having an aspect ratio above 10, wherein a majority of the electronically conductive elongated nanoparticles are extended primarily in the x-y directions of the hydrogel; and
50-95 vol % aqueous electrolyte of the total volume of the hydrogel, preferably 70-90 vol % aqueous electrolyte, wherein the density of the hydrogel varies periodically along the z-axis of the hydrogel, providing alternating loose layers and dense layers.

2: The hydrogel according to claim 1, wherein the layered structure has an average pore size of above 20 nm when in a dry state excluding the aqueous electrolyte.

3: The hydrogel according to claim 1, wherein the hydrophilic nanofibril material comprises cellulose nanofibrils.

4: The hydrogel according to claim 3, wherein 90% of the cellulose nanofibrils have a width of 1.5-3.5 nm, and a length of 0.5-1.5 μm.

5: The hydrogel according to claim 1, wherein the electronically conductive elongated nanoparticles are selected from the group consisting of carbon nanotubes (CNTs), graphene, MXene, or any mixture of those.

6: The hydrogel according to claim 5, wherein the electronically conductive elongated nanoparticles are CNTs; and
the amount of electronically conductive elongated nanoparticles in the hydrogel is 30-60 wt % of the total weight of the layers.

7: The hydrogel according to claim 6, wherein 90% of the CNTs have a width of 4-10 nm and a length of 1.2-2 μm.

8: The hydrogel according to claim 1, wherein the hydrophilic nanofibril material is selected from the group consisting of cellulose nanofibrils, protein nanofibrils, chitin nanofibrils, and mixtures of those.

9: The hydrogel according to claim 1, wherein the hydrophilic nanofibril material is anionically or cationically charged.

10: The hydrogel according to claim 1, wherein the electronically conductive elongated nanoparticles have an average aspect ratio of or above 100.

11: The hydrogel according to claim 1, wherein an average thickness of the layers is 200-500 nm.

12: An actuator comprising the anisotropic and electronically conducting hydrogel according to claim 1.

13: A tunable membrane comprising the anisotropic and electronically conducting hydrogel according to claim 1.

14: A method of forming a hydrogel, wherein the method comprises the steps of:
dispersion of hydrophilic nanofibrils, preferably cellulose nanofibrils, and electronically conductive elongated nanoparticles with an aspect ratio of 10 or higher in water to form a dispersion;
filtration of the dispersion to form an anisotropic wet sheet;
drying the wet sheet for a pre-determined time period to form a dried layered structure; and
immersing the dried layered structure in an aqueous electrolyte.
